(19) United States
(12) Patent Application Publication
(10) Pub. No.: US 2007/0265378 A1
(43) Pub. Date: Nov. 15, 2007

(54) Polyvinyl Chloride Fiber Reduced in Initial Coloration

(75) Inventors: Toshiyuki Kawaguchi, Osaka (JP); Yuichi Ohyama, Osaka (JP); Toshihiko Hirose, Shiga (JP)

Correspondence Address: HAMRE, SCHUMANN, MUELLER & LARSON, P.C., P.O. BOX 2902, MINNEAPOLIS, MN, 55402-0902, US

(73) Assignee: KANEKA CORPORATION, OSAKA (JP)

(21) Appl. No.: 11/663,467

(22) PCT Filed: Sep. 29, 2005
(86) PCT No.: PCT/JP05/17940

§ 371 Date: Mar. 22, 2007

(30) Foreign Application Priority Data
Sep. 29, 2004 (JP) 2004-285209

(51) Int. Cl. C08K 5/07; A41G 3/00; D01F 6/48

(52) U.S. Cl. 524/396; 524/394

(57) ABSTRACT

The polyvinyl chloride-based fiber of the present invention is a polyvinyl chloride-based fiber formed of a vinyl chloride-based resin composition that is obtained by blending, with respect to 100 parts by weight of a mixture (a) containing 95 wt % to 50 wt % of a vinyl chloride-based resin and 5 wt % to 50 wt % of a chlorinated vinyl chloride resin, 0.5 parts by weight to 3 parts by weight of a hydrotalcite-based thermostabilizer (b), 0.5 parts by weight to 2 parts by weight of a metallic soap-based thermostabilizer (c), and 0.5 parts by weight to 1.2 parts by weight of β-diketone as a stabilizing aid (d). This polyvinyl chloride-based fiber has excellent spinnability, excellent transparency, small initial coloration and excellent colorability, and thus has a high commercial value as artificial hair for hair adornment, and can be used widely for practical goods and fashion purposes. Moreover, due to this property, the polyvinyl chloride-based fiber also can be applied to a field of industrial materials and the like besides artificial hair.

### TECHNICAL FIELD

The present invention relates to a polyvinyl chloride-based fiber for artificial hair that has high transparency, low initial coloration and excellent colorability.

### BACKGROUND ART

As a stabilizer for vinyl chloride, a heavy metal-based stabilizer (for example, Pb, Cd and Ba) and an organic Sn-based stabilizer have been used conventionally, but the former has a problem in safety, and the latter is expensive and has a problem of odor and the like caused by malate and mercapto.

Thus, a metallic soap-based stabilizer including a Ca—Zn-based stabilizer has been used recently (see Patent documents 1 and 2). However, in this blend system, the prevention of initial coloration is insufficient, for example, for the purpose of blending a chlorinated vinyl chloride resin in order to improve heat resistance, the initial colorability is high and thus yellowing occurs at the time of processing, and even when a complementary color is supplied thereto using blue colorant in order to cancel this yellowing, so-called “somberness” occurs and brightness is decreased, which leads to a decrease in the sharpness of a color tone, thereby decreasing the commercial value as the artificial hair significantly.

Patent document 1: JP 2001-98413 A

Patent document 2: JP 2001-98414 A

### DISCLOSURE OF INVENTION

### Problem to be Solved by the Invention

It is an object of the present invention to provide a polyvinyl chloride-based fiber, which uses a vinyl chloride-based resin and a chlorinated vinyl chloride resin that are blended in combination in order to obtain a polyvinyl chloride-based fiber having heat resistance, and has excellent transparency and low initial coloration even in the case of using a metallic soap-based stabilizer as a stabilizer.

### Means for Solving Problem

As a result of a keen study for solving the above-described problems, the inventors of the present invention have reached the present invention that can attain the above-described problems by adding a certain amount of β-diketone to a composition containing a vinyl chloride-based resin and a chlorinated vinyl chloride resin in combination, which is stabilized by a metallic soap system and a hydrotalcite-based stabilizer.

That is, the polyvinyl chloride-based fiber of the present invention is a polyvinyl chloride-based fiber which is formed of a vinyl chloride-based resin composition that is obtained by blending, with respect to 100 parts by weight of a mixture (a) containing 95 wt % to 50 wt % of a vinyl chloride-based resin and 5 wt % to 50 wt % of a chlorinated vinyl chloride resin, 0.5 parts by weight to 3 parts by weight of a hydrotalcite-based thermostabilizer (b), 0.5 parts by weight to 2 parts by weight of a metallic soap-based thermostabilizer (c), and 0.5 parts by weight to 1.2 parts by weight of β-diketone as a stabilizing aid (d).

### EFFECTS OF THE INVENTION

The polyvinyl chloride-based fiber according to the present invention has excellent spinnability, excellent transparency, small initial coloration and excellent colorability, thus has a high commercial value as artificial hair for hair adornment, and can be used widely for practical goods and fashion purposes. Moreover, due to this property, the polyvinyl chloride-based fiber also can be applied to a field of industrial materials and the like besides artificial hair.

### DESCRIPTION OF THE INVENTION

The vinyl chloride-based resin used as one of the components (a) of the present invention is a homopolymer resin that is a homopolymer of conventionally known vinyl chloride or various types of conventionally known copolymer resins, and is not limited particularly. As the copolymer resin, conventionally known copolymer resins can be used, and representative examples thereof include: copolymer resins of vinyl chloride and vinyl ester such as a vinyl chloride-vinyl acetate copolymer resin and a vinyl chloride-vinyl propionate copolymer; copolymer resins of vinyl chloride and acrylic ester such as a vinyl chloride-butyl acrylate copolymer resin and a vinyl chloride-2-ethylhexyl acrylate copolymer; copolymer resins of vinyl chloride and olefin such as a vinyl chloride-ethylene copolymer resin and a vinyl chloride-propylene copolymer resin; and vinyl chloride-acrylonitrile copolymer resins. Particularly preferably, a homopolymer resin that is a homopolymer of vinyl chloride, a vinyl chloride-ethylene copolymer resin, a vinyl chloride-vinyl acetate copolymer resin and the like are used. In the copolymer resin, a content of a comonomer is not limited particularly, and can be determined according to required properties such as moldability and filament properties.

A viscosity average degree of polymerization of the vinyl chloride-based resin used in the present invention preferably ranges from 450 to 1800. The viscosity average degree of the polymerization of less than 450 is not preferable, because the strength and heat resistance of the fiber deteriorate. On the other hand, if the viscosity average degree of the polymerization is more than 1800, since the melt viscosity is increased, a nozzle pressure is increased, by which safe manufacturing tends to be difficult. In the light of a balance between the moldability and the fiber properties, in the case of using a homopolymer resin that is a homopolymer of vinyl chloride, the viscosity average degree of the polymerization particularly preferably ranges from 650 to 1450, and in the case of using a copolymer, the viscosity average degree of the polymerization particularly preferably ranges from 1000 to 1700, which also depends on the content of the comonomer though. Herein, the viscosity average degree of the polymerization is obtained by dissolving 200 mg of the resin in 50 ml of nitrobenzene, measuring a specific viscosity of this polymer solution in a thermostat at 30° C. by using an Ubbelohde type viscometer, and calculating based on JIS-K₆₇₂₁.

Moreover, as the vinyl chloride-based resin used in the present invention, a vinyl chloride-based resin that is manufactured by emulsion polymerization, block polymerization, suspension polymerization or the like may be used, but a vinyl chloride-based resin that is manufactured by suspension polymerization is preferably used, considering the initial colorability of the fiber and the like.

The chlorinated vinyl chloride resin that is used as the other one of the components (a) of the present invention in combination with the vinyl chloride-based resin means a vinyl chloride resin that is post-chlorinated so as to contain chlorine of 56.7 wt % or more. If a degree of chlorination is too small, an improving effect of the heat resistance is small, and if the degree of chlorination is too large, the processibility deteriorates, and heating and discoloration occur at the time of the processing, and thus the content of the chlorine preferably ranges from 58 wt % to 70 wt %, and more preferably ranges from 63 wt % to 68 wt %. A method for the chlorination may be conducted in either a gas phase or a liquid phase, and the vinyl chloride resin to be chlorinated may be polymerized by a method such as block polymerization, suspension polymerization or other method that is particularly advantageous for the chlorination, and a degree of the polymerization of this chlorinated vinyl chloride resin preferably ranges from about 400 to about 1000 in the light of the processibility.

By using the vinyl chloride-based resin and the chlorinated vinyl chloride resin in combination, heat resistance of the obtained polyvinyl chloride-based fiber is improved, and a luster and a feeling thereof also are controlled. In this case, a mixture ratio between both of the resins is 50 wt % to 95 wt % of the vinyl chloride-based resin and 5 wt % to 50 wt % of the chlorinated vinyl chloride resin. In the case where the content of the chlorinated vinyl chloride resin is less than 5 wt %, the matting and the heat resistance are not effectively improved, and in the case where the content of the chlorinated vinyl chloride resin is more than 50 wt %, the thermostability during the heat processing is decreased significantly, and thus the continuous spinning over a long period of time becomes difficult. Further, in the case of more than 50 wt %, even when increasing an added amount of β-diketone, the initial coloration cannot be suppressed, and the transparency deteriorates. From these points, the content of the chlorinated vinyl chloride resin more preferably ranges from 10 wt % to 45 wt %.

As a thermostabilizer to be used for a component (b) of the present invention, 0.5 parts by weight to 3 parts by weight of a hydrotalcite-based thermostabilizer and 0.5 parts by weight to 2 parts by weight of a metallic soap-based thermostabilizer preferably are used in combination. The hydrotalcite-based thermostabilizer is an anion exchangeable layered compound that contains, as a main component, magnesium-aluminum-hydroxide-carbonate-hydrate in chemical name represented by a general formula (I) below.
MgₓAl₂(OH)₍₂ₓ₊₄₎CO₃nH₂O] (1)
The hydrotalcite-based compound functions as a thermostabilizer due to its HCl-trapping effect. As is disclosed in JP 4(1992)-73457 B, a hydrotalcite-based themostabilizer that has a part of magnesium substituted by Ca or Zn, or is processed with various types of surface treating agents can also be used. A commercially available hydrotalcite-based themostabilizer includes, for example, ALCAMIZER (product name) manufactured by Kyowa Chemical Industry Co., Ltd. and the like. An added amount of the hydrotalcite-based themostabilizer preferably ranges from 0.5 parts by weight to 3 parts by weight. In the case where the added amount is less than 0.5 parts by weight, the effect as the thermostabilizer is small, and in the case where the added amount is more than 3 parts by weight, generation of a deteriorated resin and occurrence of filament breakage are increased, and nozzle ejections of a multifilament become ununiform. Further preferably, the added amount ranges from 1 part by weight to 2 parts by weight.

Moreover, the metallic soap-based thermostabilizer that is a component (c) of the present invention is a generic name of a metal salt of an organic acid such as long-chain fatty acid, naphthenic acid and resinate, and the metal is preferably Ca, Mg and Zn, and the fatty acid is preferably lauric acid, palmitic acid, stearic acid, oleic acid, ricinoleic acid and derivatives thereof. An added amount of the metallic soap-based thermostabilizer preferably ranges from 0.5 parts by weight to 2 parts by weight. In the case where the added amount is less than 0.5 parts by weight, the effect as the thermostabilizer is small, and in the case where the amount is more than 2 parts by weight, the generation of a deteriorated resin and the occurrence of filament breakage are increased.

The β-diketone used as a component (d) of the present invention is added as a thermostabilizing aid in order to suppress the initial coloration at the time of the processing, and may be acetylacetone, benzoylacetone, stearoylbenzoylmethane (SBM), dibenzoylmethane (DBM), ethyl acetoacetate, dehydroacetic acid and the like. Among them, SBM and DBM are preferable in the light of the initial coloration suppressing effect. Since, in a mixed system of the vinyl chloride-based resin and the chlorinated vinyl chloride resin, when the added amount is less than 0.5 parts by weight, the effect is not exhibited, and when the added amount is more than 1.2 parts by weight, the effect reaches a level of saturation, the added amount preferably ranges from 0.5 parts by weight to 1.2 parts by weight. In the present invention, a general plasticizer also can be blended. Examples of the plasticizer that can be used include: a phthalic acid-based plasticizer such as dibutyl phthalate, di-2-ethylhexyl phthalate and diisononyl phthalate; a trimellitic acid-based plasticizer such as octyltrimellitate; a pyromellitic acid-based plasticizer such as octylpyromellitate; a polyester-based plasticizer; and an epoxy-based plasticizer such as an epoxidized soybean oil. These plasticizers may be used alone or in combination of two kinds or more.

In the present invention, the above-described plasticizers have an effect for decreasing a viscosity of the mixture of the vinyl chloride-based resin and the chlorinated vinyl chloride resin at the time of spinning, decreasing a nozzle pressure of the spinning machine and improving the filament breakage. An amount of the plasticizer to be used ranges from 0.2 parts by weight to 5 parts by weight, and preferably ranges from 0.2 parts by weight to 3 parts by weight with respect to 100 parts by weight of the total amount of the vinyl chloride-based resin and the chlorinated vinyl chloride resin. In the case where the amount is less than 0.2 parts by weight, occurrence of unifilar filament breakage is increased and the nozzle pressure of the spinning machine is increased at the time of melt spinning. In the case where the amount is more than 5 parts by weight, the heat resistance of the polyvinyl chloride-based fiber that is manufactured from these resin compositions is decreased, thus being not preferable. A lubricant used in the present invention may be a conventionally known lubricant, but in particular, 0.2 parts by weight to 5.0 parts by weight of one or more kinds selected from a polyethylene-based lubricant, a higher fatty acid-based lubricant, an ester-based lubricant and a higher alcohol-based lubricant preferably are used with respect to 100 parts by weight of the vinyl chloride-based resin. More preferably, 1 part by weight to 4 parts by weight thereof is used. The lubricant is effective for controlling a melting state of the composition and a state of adhesion of the composition with a metal surface in an extruder and metal surfaces of a screw, a cylinder, dies and the like. In the case where the amount of the lubricant is less than 0.2 parts by weight, the production efficiency is decreased due to an increase of a die pressure and a decrease of an discharge amount at the time of the production, and further, filament breakage and the increase of the nozzle pressure are likely to occur, whereby the stable production becomes difficult. In the case where the amount is more than 5 parts by weight, due to the decrease of the discharge amount, the frequent occurrence of the filament breakage and the like, the stable production becomes difficult similarly to the case where the amount is less than 0.2 parts by weight, and the fiber with high transparency tends not to be obtained, thus being not preferable.

In the present invention, another known compounding agent that is used for the vinyl chloride-based composition may be added as necessary within a range that does not inhibit the effect of the present invention. Examples of the compounding agent include: a processibility improving agent; a stabilizing aid; an antistatic agent; a colorant; an ultraviolet absorber; a perfume; and the like.

As the processibility improving agent, a known processibility improving agent can be used. For example, an acrylic processibility improving agent containing methyl methacrylate as a main component; an EVA-based processibility improving agent containing an ethylene-vinyl acetate copolymer resin (EVA) as a component; an EEA-based processibility improving agent containing an ethylene-ethyl acrylate copolymer resin (EEA) as a component; and the like may be used. An amount of the processibility improving agent to be used preferably ranges from about 0.2 parts by weight to about 12 parts by weight with respect to 100 parts by weight of the vinyl chloride-based resin. Moreover, these processibility improving agents may be used alone or in combination of two kinds or more. When the stabilizing aid is used alone, the stabilizing action is not sufficient, but when it is used with a main stabilizer such as hydrotalcite and a metallic soap so as to improve weaknesses and imperfections of them. Other than β-diketone and epoxy compounds, phosphite and polyol may be used. Examples of the phosphate include: trialkyl phosphate; alkylaryl phosphate; triallyl phosphate; and the like. Examples of the polyol include: glycerin; sorbitol; mannitol; pentaerythritol; and the like. The polyvinyl chloride-based fiber of the present invention is manufactured by a known melt spinning method. For example, a vinyl chloride-based resin, a chlorinated vinyl chloride resin, a processibility improving agent, a plasticizer, a thermostabilizer, a lubricant and the like are mixed in a predetermined ratio, are stirred and mixed by using a Henschel mixer or the like, subsequently are filled in an extruder, are extruded at a cylinder temperature ranging from 130° C. to 190° C. and a nozzle temperature within a range of 180±15° C. under a condition of good spinnability, are treated by heat for about 0.5 seconds to about 1.5 seconds in a heated spinning chimney that is provided directly beneath the nozzle (in an atmosphere ranging from 200° C. to 300° C. under a condition of good spinnability), and are spun by using a first drawing roll so as to manufacture an undrawn filament in a state of fiber. Thereafter, the undrawn filament is drawn three times between the second drawing roll by being passed through a hot-air circulating box at 110° C., is drawn between two pairs of conical rolls that are disposed in a box at a controlled temperature of 110° C., is subjected to releasing treatment at about 25% continuously, and is wound by a multifilament, thereby manufacturing the polyvinyl chloride-based fiber of the present invention.

The vinyl chloride-based resin composition used in the present invention can be used as a powder compound that is made by using a conventionally known mixer, for example, a Henschel mixer, a super mixer, a ribbon blender or the like, or a pellet compound made by melting and mixing them. The powder compound can be manufactured under a conventionally known common condition, which may be hot blending or cold blending. Particularly preferably, the hot blending in which a cut temperature is increased to 105° C. to 155° C. during blending in order to reduce a volatile component in the composition preferably is used. The pellet compound can be manufactured similarly to the manufacture of a common vinyl chloride-based pellet compound. For example, the pellet compound can be manufactured by using a monoaxial extruder, a same direction biaxial extruder, a different direction biaxial extruder, a conical biaxial extruder, a Ko-kneader, and a kneader such as a roll kneader. The condition when manufacturing the pellet compound is not limited particularly, but a resin temperature is preferably set at 185° C. or less in order to prevent thermal degradation of the vinyl chloride-based resin. Moreover, in order to remove a foreign matter such as a metal piece of a cleaning tool that may be mixed into the pellet compound, a fine-meshed stainless mesh or the like may be disposed in the kneader, a means for removing “cuttings” and the like that may be mixed during the cold cutting is achieved, or the hot cutting is performed, which can be selected freely, but it is particularly preferable to use the hot cutting method in which less “cuttings” are mixed therein.

Moreover, when processing the vinyl chloride-based resin compound into a fiber-type undrawn filament, a conventionally known extruder can be used. For example, a monoaxial extruder, a different direction biaxial extruder, a conical biaxial extruder and the like may be used, but particularly preferably, a monoaxial extruder with a bore ranging from about 30 mmφ to about 50 mmφ or a conical extruder with a bore ranging from about 30 mmφ to about 50 mmφ is used. When the bore is too large, an amount of extrusion is large, and the nozzle pressure is too high, whereby an outflowing speed of the undrawn filament is too high, and the winding tends to be difficult, which is not preferable.

In the present invention, the nozzle pressure during the melt spinning is preferably 50 MPa or less. When the nozzle pressure is higher than 50 MPa, a malfunction is likely to occur at a thrust section of the extruder, and a “resin leakage” is likely to occur at a connection portion of a crosshead, a die or the like, which is not preferable. The nozzle pressure can be decreased by increasing the resin temperature, but under the temperature condition during the melt spinning, the spinning is preferably performed at the resin temperature of 195° C. or less. If the spinning is performed under a condition at the resin temperature of more than 195° C., the coloration trend of the fiber becomes significant, and the color of the fiber becomes strong yellow, which is not preferable. Thus, it is particularly preferable that the cylinder temperature of the extruder ranges from about 140° C. to about 185° C., and the temperature of the die or the nozzle ranges from about 160° C. to about 190° C.

In the present invention, the melt spinning can be performed by using a conventionally known nozzle, but considering properties such as a touch feeling, it is preferably performed by attaching, to a die tip portion, nozzles each of which has a nozzle hole with a cross-sectional area of 0.5 mm² or less. When using the nozzle with the cross-sectional area of more than 0.5 mm², in order to obtain a predetermined fineness of the undrawn filament, it becomes necessary to melt and extrude the compound sufficiently at a high temperature, and draw it with a high spinning draft. This is not preferable, because a surface of the fiber becomes too smooth, a smooth touch feeling like a plastic is obtained, and a dry touch feeling like human hair cannot be obtained. It is preferable to draw an undrawn filament with a fineness of 300 dtexes or less by using the nozzles each of which has a nozzle hole with a cross-sectional area of 0.5 mm² or less. In the case where the undrawn filament is more than 300 dtexes, a drawing ratio is required to be increased at the time of the drawing treatment, in order to obtain a fiber with a small fineness. Thus, the surface of the fiber becomes too smooth, and a smooth touch feeling like a plastic is obtained, and a dry touch feeling like human hair cannot be obtained, which is not preferable.

### EXAMPLE

Examples will be described below so as to explain specific embodiments of the present invention in further detail, but the present invention will not be limited to these examples. Incidentally, 1.3 parts by weight of EEA (“PES-250” as product name, produced by Nippon Unicar Company Limited) as a processibility improving agent, 0.3 parts by weight of phosphate (“SC-126” as product name, produced by ADEKA CORPORATION) as a stabilizing aid, 0.6 parts by weight of an epoxidized soybean oil (“W-100-EL” as product name, produced by DAINIPPON INK AND CHEMICALS, INCORPORATED) as a plasticizer, 0.8 parts by weight of an ester-based lubricant (“EW-100” as product name, produced by Riken Vitamin Co., Ltd.) and 0.4 parts by weight of “G70” as product name (produced by Cognis Japan Ltd.) as a lubricant, and 0.5 parts by weight of a polyethylene wax-based lubricant (“HW400P” as product name, produced by Mitsui Chemicals, Inc.) as a lubricant were blended in all of the examples and comparative examples, which are not described in Table 1.

[Table 1]

TABLE 1

| | | Example | | | | | | | | | Comparative Example | | | | |
|---|---|---|---|---|---|---|---|---|---|---|---|---|---|---|---|
| | | 1 | 2 | 3 | 4 | 5 | 6 | 7 | 8 | 9 | 1 | 2 | 3 | 4 | 5 |
| blend | S1001/H438 | 88/12 | 88/12 | 88/12 | 88/12 | 88/12 | 88/12 | 60/40 | 88/12 | 88/12 | 100/0 | 88/12 | 88/12 | 88/12 | 88/12 |
| PHR | ALCAMIZER | 1.5 | 1.5 | 1.5 | 1.5 | 1.5 | 1.5 | 1.5 | 1.5 | 3 | 1.5 | 1.5 | 1.5 | 0.4 | 5 |
| | 1 | | | | | | | | | | | | | | |
| | AD157 | | | | | 0.5 | 0.25 | | | | | | | | |
| | AD158 | 0.5 | 0.8 | 1.2 | 0.5 | | 0.25 | 1.2 | 0.5 | 0.5 | 0.3 | 0.3 | 0.3 | 0.5 | 0.5 |
| | SC-120H | 0.6 | 0.6 | 0.6 | | 0.6 | 0.6 | 0.6 | 1.0 | 0.6 | 0.6 | 0.6 | | 0.6 | 0.6 |
| | SM-120H | | | | 0.6 | | | | | | | | 0.6 | | |
| | SZ-120H | 0.6 | 0.6 | 0.6 | 0.6 | 0.6 | 0.6 | 0.6 | 1.0 | 0.6 | 0.6 | 0.6 | 0.6 | 0.6 | 0.6 |
| heat resistance | | B | B | B | B | B | B | A | B | B | C | B | B | B | B |
| press | total light ray | 80 | 80 | 79 | 79 | 82 | 81 | 70 | 77 | 72 | 83 | 78 | 76 | 76 | 52 |
| plate | transmittance | | | | | | | | | | | | | | |
| | (%) | | | | | | | | | | | | | | |
| | yellowness | 38 | 39 | 38 | 45 | 41 | 40 | 49 | 40 | 42 | 36 | 53 | 52 | 66 | 33 |
| | index | | | | | | | | | | | | | | |
| GO | coloration after | A | A | A | B | B-A | A | B | A | A | A | B | B-C | B | A |
| evaluation | 5 min | | | | | | | | | | | | | | |
| | time for | 45 | 45 | 45 | 40 | 50 | 45-50 | 35 | 50 | 50 | 50 | 40 | 40 | 30 | 60 |
| | browning (min) | | | | | | | | | | | | | | |

| | | | | | | | | | | | | | | |
|---|---|---|---|---|---|---|---|---|---|---|---|---|---|---|
| spinnability | 5 | 5 | 5 | 5 | 5 | 5 | 4 | 4 | 4 | 5 | 5 | 5 | 4 | 2 |
| undrawn filament | A | A | A | A | B-A | A | B-A | A | A | A | B | B | B | B-A |
| colorability | | | | | | | | | | | | | | |

In Table 1, a vinyl chloride resin (“S1001” as product name, produced by Kaneka Corporation, average degree of polymerization of 1000), a chlorinated vinyl chloride resin (“H438” as product name, produced by Kaneka Corporation, degree of chlorination of 64%) as a heat resistance improving agent, synthetic hydrotalcite (“ALCAMIZER 1” as product name, produced by Kyowa Chemical Industry Co., Ltd.) as a stabilizer, DBM (“AD158” as product name, produced by Sakai Chemical Industry Co., Ltd.) and SBM (“AD157” as product name, produced by Sakai Chemical Industry Co., Ltd.) as β-diketone, calcium 12-hydroxystearate (“SC12OH” as product name, produced by Sakai Chemical Industry Co., Ltd.) as a calcium soap, zinc 12-hydroxystearate (“SZ12OH” as product name, produced by Sakai Chemical Industry Co., Ltd.) as a zinc soap, and magnesium 12-hydroxystearate (“SM12OH” as product name, produced by Sakai Chemical Industry Co., Ltd.) as a magnesium soap were used.

(1) Heat Resistance

The blended resin in Table 1 was kneaded by a roll kneader at 185° C. for 5 minutes so as to manufacture a roll sheet, thereafter, this roll sheet was superimposed, and was pressed at 190° C. for 10 minutes so as to manufacture a press plate with a thickness of 3 mm, and then, a Vicat softening temperature thereof with a load of 5 kg was measured by using a VSPT. TESTER manufactured by TOYO SEIKI KOGYO CO., LTD. The evaluation is represented by A, B and C so that A represents that the Vicat softening temperature was more than 84° C., B represents that the Vicat softening temperature ranged from 82° C. to 84° C., and C represents that the Vicat softening temperature was less than 82° C.

(2) Press Plate Transparency Evaluation (Tg %)

The blended resin in Table 1 was kneaded by using the roll kneader at 185° C. for 5 minutes so as to manufacture a roll sheet, subsequently was pressed at 190° C. for 10 minutes so as to manufacture a press plate with a thickness of 1 mm, and a total light ray transmittance (Tt %) thereof was measured by using a haze meter NDH2000 produced by Nippon Denshoku Industries Co., Ltd.
total light ray transmittance Tt(%)=T2/T1×100

(Herein, T1: incident light amount (100), T2: total transmitted light ray amount)

(3) Yellowness Index of Press Plate

A yellowness index (Y1) of the above-described press plate with the thickness of 1 mm was measured by using a color meter ZE2000 produced by Nippon Denshoku Industries Co., Ltd.

(4) Gear Oven (GO) Evaluation

The above-described roll sheet was cut, which was put into an oven at an adjusted temperature of 195° C., and was taken out sequentially every 5 minutes, and colorability after 5 minutes and a time for browning were evaluated. Specifically, A represents that the sample taken out after 5 minutes was not yellowed, B represents that the sample was yellowed slightly, and C represents that the sample was yellowed. The time for browning represents a time when the yellowing further proceeded and reached the color of brown.

(5) Spinnability Evaluation

In a step of melt spinning, a condition of filament breakage occurring was observed visually, and was evaluated in five levels as follows.
5: filament breakage occurred once or less/1 hour
4: filament breakage occurred twice or three times/1 hour
3: filament breakage occurred four times to six times/1 hour
2: filament breakage occurred seven times to fourteen times/1 hour
1: filament breakage occurred fifteen times or more/1 hour

(6) Colorability of Drawn Filament

The fiber after being drawn was observed visually, and the fibers were evaluated so that A represents the fiber that was not yellowed, and B represents the fiber that was yellowed slightly.

### Examples 1 to 9 and Comparative Examples 1 to 5

100 parts by weight of 6 kg of a total sum of the vinyl chloride-based resin and the chlorinated vinyl chloride resin shown in Table 1 below, respective compounding agents and predetermined common compounding agents were put into a 20 L Henschel mixer and were stirred and mixed. Thereafter, a nozzle with 120 pores having a pore cross-sectional area of 0.1 mm² was attached to an extruder of 30 mmφ, extrusion was performed at a cylinder temperature within a range from 150° C. to 190° C. and a nozzle temperature within a range of 180±15° C. under a condition with excellent spinnability, heat treatment was performed in a heated spinning chimney (under a condition of excellent spinnability in an atmosphere ranging from 200° C. to 300° C.) that was provided directly beneath the nozzle for about 0.5 seconds to about 1.5 seconds, and spinning was performed by a first drawing roll. Next, it was drawn three times by being passed between the second drawing roll through a hot-air circulating box at 110° C. Further, it was drawn between two pairs of conical rolls that were disposed in a box at a controlled temperature of 110° C., was subjected to releasing treatment of about 25% continuously, and a multifilament with an unifilar filament fineness of 78 dtexes was wound. The processibility (spinnability) at this time and physical properties of the obtained multifilament were evaluated by the above-described methods, and the results are shown in Table 1.

For Comparative Examples 1 and 2, the heat resistance was low in Comparative Example 1 in which chlorinated vinyl chloride was not used, and the heat resistance was improved also in the case of using chlorinated vinyl chloride in combination, but the total light ray transmittance was decreased and the yellowness index was increased with 0.3 parts by weight of β-diketone with respect to 100 parts by weight of the component (a). Moreover, for Examples 3 and 7, when the amount of chlorinated vinyl chloride to be used was increased, the heat resistance was improved but the transparency (total light ray transmittance) was decreased, and the added amount preferably was 5 wt % to 50 wt % with respect to the total amount of the component (a).

As is recognized from Comparative Example 2 and Examples 1, 2 and 3, in the system using the vinyl chloride-based resin and the chlorinated vinyl chloride resin in combination, the yellowness index was high with 0.3 parts by weight of β-diketone with respect to 100 parts by weight of the component (a), but when blending 0.5 parts by weight or more of β-diketone, while the total light ray transmittance was maintained, the yellowness index was decreased. Also in the gear oven (GO) evaluation, the coloration after 5 minutes was not observed, and the time for browning was extended by 5 minutes, thus recognizing the improvement of the initial colorability and the thermostability. However, it should be noted that the effect reached a level of saturation when adding 0.8 parts by weight, and it is preferable to blend 1.0 part by weight or less in the case of considering the economical efficiency.

As is recognized from Comparative Example 3 and Example 4, also in the case of replacing the metallic soap of a calcium-zinc system by that of a magnesium-zinc system, by blending 0.5 parts by weight or more of β-diketone with respect to 100 parts by weight of the component (a), the yellowness index was decreased while maintaining the total light ray transmittance. Moreover, from Examples 1 and 8, in the case of increasing the added amount of the metallic soap, the spinnability tended to be decreased, and thus the added amount thereof preferably is 2 parts by weight or less with respect to 100 parts by weight of the component (a).

As is recognized from Comparative Examples 4 and 5 and Examples 1 and 9, when the added amount of hydrotalcite was less than 0.5 parts by weight with respect to 100 parts by weight of the component (a), the thermostability was decreased and the time for GO browning was decreased, and when the added amount was more than 3 parts by weight, filament breakage occurred due to reaggregation of hydrotalcite.

As is recognized from Examples 1, 5 and 6, in the case of using DBM alone for β-diketone, the improving effect of the initial coloration was high, but retention of the thermostability (the time for the GO browning) was short. Moreover, in the case of using SBM alone, the improving effect of the initial coloration was low, but the retention of the thermostability (the time for the GO browning) was long. Further, in the case of using DBM and SBM in combination, the thermostability and the initial colorability were improved in good balance.

1-3. (canceled)

4. A polyvinyl chloride-based fiber formed of a vinyl chloride-based resin composition that is obtained by blending, with respect to 100 parts by weight of a mixture (a) containing 95 wt % to 50 wt % of a vinyl chloride-based resin and 5 wt % to 50 wt % of a chlorinated vinyl chloride resin, 0.5 parts by weight to 3 parts by weight of a hydrotalcite-based thermostabilizer (b), 0.5 parts by weight to 2 parts by weight of a metallic soap-based thermostabilizer (c), and 0.5 parts by weight to 1.2 parts by weight of β-diketone as a stabilizing aid (d).

5. The polyvinyl chloride-based fiber according to claim 4, wherein the metallic soap-based stabilizer that is the component (c) is at least one selected from a calcium soap, a zinc soap and a magnesium soap, and is a higher fatty acid and/or a derivative thereof

6. The polyvinyl chloride-based fiber according to claim 4, wherein β-diketone that is the stabilizing aid of the component (d) is at least one selected from stearylbenzoylmethane (SBM) and dibenzoylmethane (DBM).

7. The polyvinyl chloride-based fiber according to claim 4, wherein the vinyl chloride-based resin of the component (a) is a resin composed of a homopolymer of vinyl chloride or a copolymer containing vinyl chloride.

8. The polyvinyl chloride-based fiber according to claim 7, wherein the resin composed of the copolymer containing vinyl chloride is at least one selected from a copolymer resin of vinyl chloride and vinyl ester, a copolymer resin of vinyl chloride and acrylic ester, a copolymer resin of vinyl chloride and olefin, and a copolymer resin of vinyl chloride and acrylonitrile.

9. The polyvinyl chloride-based fiber according to claim 4, wherein a viscosity average degree of polymerization of the vinyl chloride-based resin of the component (a) ranges from 450 to 1800.

10. The polyvinyl chloride-based fiber according to claim 4, wherein the chlorinated vinyl chloride resin of the component (a) is a vinyl chloride resin that is post-chlorinated so as to contain chlorine in an amount of 56.7% or more.

11. The polyvinyl chloride-based fiber according to claim 4, wherein a mixture ratio of the vinyl chloride-based resin and the chlorinated vinyl chloride resin of the component (a) is within a range of 50 wt % to 95 wt % of the vinyl chloride-based resin and 5 wt % to 50 wt % of the chlorinated vinyl chloride resin.

12. The polyvinyl chloride-based fiber according to claim 4, wherein at least one plasticizer selected from a phthalic acid-based plasticizer, a trimellitic acid-based plasticizer, a pyromellitic acid-based plasticizer, a polyester-based plasticizer and an epoxy-based plasticizer are further added to the polyvinyl chloride-based fiber.

13. The polyvinyl chloride-based fiber according to claim 6, wherein an added ratio of the plasticizer ranges from 0.2 parts by weight to 5 parts by weight, with respect to 100 parts by weight of a total of the vinyl chloride-based resin and the chlorinated vinyl chloride resin.
